(19) United States
(12) Patent Application Publication
(10) Pub. No.: US 2004/0140894 A1
(43) Pub. Date: Jul. 22, 2004

(54) Remote controls, remote locator

(76) Inventors: Grigore Diaconu, North Miami Beach, FL (US); Ilioara Diaconu, North Miami Beach, FL (US); Maria Tudorita Diaconu, North Miami Beach, FL (US)

Correspondence Address: GRIGORE DIACONU, 16950 WEST DIXIE HWY., # 230, NORTH MIAMI BEACH, FL, 33160, US

(21) Appl. No.: 10/347,469

(22) Filed: Jan. 21, 2003

(51) Int. Cl. G08B 1/08

(52) U.S. Cl. 340/539.32

(57) ABSTRACT

We used three electronic systems:

1) A VCR: AC/DC 120V 60 Hz 18 W

2) wireless chime # SL-6150-C:

a)-a push button transmitter ( range of up to 100 feet)

b)-chime unit with its speaker

3) AC/CD adaptor: model # KW 130 RB input AC 120 V 60 Hz 7 W, output DC 9V

we took the front cover of the VCR, made a round hole of approximately ½ inch on the left side

on the inside of the cover, we attached the push button transmitter, where instead of the battery we connected the AC/DC adaptor (AC 120V to DC9V)

then placed the cover back on the VCR

we took it apart the remote control from the VCR and adapted the electronic board from the chime unit with the speaker to the remote control

we put everything back together and put the VCR in its place

### BACKGROUND OF INVENTION

From the time the remote controls for electronic devices were first invented, people all over the world have had the annoying problem with losing the remote. Like it happened with us, we lost the TV remote control in the house for a couple of days.

### BRIEF SUMMARY OF INVENTION

Our invention relates to a wireless system, of two pieces, like a wireless chime unit to help locate a lost remote control. One piece, the push button transmitter, to be installed to any electronic device that is controlled by a remote (ex.: TV, VCR, DVD player, radio, etc.) and the second piece to be installed into the remote control. If the remote is lost, by pressing the button on the electronic device you will activate the system installed into the remote, which will start beeping, helping you to track it down.

### DETAILED DESCRIPTION OF INVENTION

This idea came to us after losing the remote control for a couple of days. After we found it we though that it would be a good idea if someone came up with an remote locator system for the remote control like there is for the wireless phones. So we decided to built one. And we did and use it in our house, it works great.

We took a chime unit for the door and took it apart. We installed the push button transmitter into the VCR, we cut a small, round hole into the front of the VCR so that the button could come out from the inside. Then we took the board from inside the chime unit with the speaker and attached it to the remote control, we connected the wires so that the chime unit board and speaker would work with the batteries from the remote control so extra batteries for the chime unit wouldn't be needed.

Where ever the remote control from the VCR is, we press the transmitter button from the VCR and the speaker from the remote control starts beeping. Of course, the push button transmitter could be installed into any electronic device and the unit with the speaker into any remote control that corresponds to that electronic device.

We claim for our invention a two piece system:

1. one, a push button transmitter, to be installed into any electronic device that is controlled by a remote (ex.: TV, VCR, DVD player, camera, etc.)
and the second piece, with a speaker, to be installed into the remote control so that by pressing the button from the system inside the electronic device will activate the system inside the remote control by making it beep, so anyone can track down the remote if its lost.
